(19) United States
(12) Patent Application Publication
(10) Pub. No.: US 2012/0283084 A1
(43) Pub. Date: Nov. 8, 2012

(54) COMPACT DUNNAGE STORAGE AND CONVERSION SYSTEM

(75) Inventors: Robert C. Cheich, Independence, OH (US); Carrie A. Schlegel, Ashtabula, OH (US); Thomas J. Mendosa, Hudson, OH (US)

(73) Assignee: RANPAK CORP., Concord Township, OH (US)

(21) Appl. No.: 13/520,369

(22) PCT Filed: Jan. 25, 2011
(86) PCT No.: PCT/US11/22396

§ 371 Date: Jul. 3, 2012

Related U.S. Application Data
(60) Provisional application No. 61/298,142, filed on Jan. 25, 2010.
(60) Provisional application No. 61/362,992, filed on Jul. 9, 2010.
(60) Provisional application No. 61/362,995, filed on Jul. 9, 2010.

(51) Int. Cl. B31F 1/00; B65D 85/62; B65D 5/72

(52) U.S. Cl. 493/464; 206/494

(57) ABSTRACT

A self-contained dunnage system includes a box sized to receive a supply of sheet stock material with minimal or no empty space when the box is closed. The box has one or more flaps that are movable between a generally planar closed position where the flaps cooperate to close the box and an inclined operating position displaced from the closed position. In the operating position, the ends of the flaps define a dispensing outlet spaced from an open side of the box defined by the side wall or walls of the box. The dispensing outlet is smaller than the open side of the box such that as the sheet material is pulled from the box and through the outlet, the inclined flaps act as a forming member that inwardly gathers the sheet material, causing it to crumple as it is withdrawn from the box.

This application claims the benefit of U.S. Provisional Patent Application No. 61/298,142, filed Jan. 25, 2010, U.S. Provisional Patent Application No. 61/362,992, filed Jul. 9, 2010, and U.S. Provisional Patent Application No. 61/362,995, filed Jul. 9, 2010, each of which is incorporated herein by reference.

### FIELD OF THE INVENTION

This invention relates generally to a dunnage conversion system for converting a sheet stock material into a dunnage product, and more particularly to such a system that provides compact, box-like storage for a supply of sheet stock material to be converted into a relatively less dense dunnage product for use in packing articles for shipment.

### BACKGROUND

In the process of shipping one or more articles in a container, such as a cardboard box, from one location to another, a packer typically places some type of dunnage material in the shipping container along with the article or articles to be shipped. The dunnage material partially or completely fills the empty space or void volume around the articles in the container. By filling the void volume, the dunnage prevents or minimizes movement of the articles that might lead to damage during the shipment process. Some commonly used dunnage materials are plastic foam peanuts, plastic bubble pack, air bags and converted paper dunnage material.

To use storage space more efficiently, a dunnage conversion machine can be used to convert a supply of stock material, such as a roll or stack of paper, into a lower density dunnage product as it is needed by the packer. For example, U.S. Pat. No. 6,676,589 discloses an exemplary dunnage conversion machine that can quickly convert a continuous sheet of paper into a crumpled strip of void-fill dunnage.

Such powered dunnage converters are well suited for high or medium volume applications. They also can be used for low volume applications where a small amount of dunnage is needed from time-to-time, but usually the cost is too high. The powered converters also are somewhat bulky and occasionally require maintenance or repair. Consequently, low volume applications typically have been serviced by other types of dunnage, such as plastic foam peanuts and manually-crumpled newspaper. Plastic foam peanuts are messy and occupy the same volume when being stored as when being used. Crumpled newspaper also is messy and requires the packer to manually crumple the newspaper.

Another apparatus for crumpling and dispensing dunnage is shown in U.S. Pat. No. 5,131,903. This apparatus includes a box-like housing holding a frame. The frame has a pair of inclined side walls for guiding sheet paper from a roll of paper through a reduced dimension corrugated-shaped opening that is generally aligned with an opening in the housing. A problem with such an apparatus is that the reduced width opening is in a frame member that forms a transversely extending shelf surrounding the opening. The paper can catch on this shelf as the paper is being pulled through the opening and can potentially cause undesirable tearing of the paper. Another perceived disadvantage is that portions of the crumpled paper cannot be efficiently and effectively separated in an easy manner. Still another disadvantage is replacement of the roll of paper is a relatively involved task, requiring disassembly of the housing and inner frame. Yet another drawback is the relatively large bulky size of the apparatus when compared to the supply of paper contained in the housing. The apparatus contains a substantial amount of empty space within the box-like housing that is not occupied by the paper roll.

### SUMMARY OF THE INVENTION

The present invention provides a self-contained dunnage system in a box. The box is sized to receive a supply of sheet stock material with minimal or no empty space when the box is closed. Yet the box has one or more flaps that are movable between a generally planar closed position where the flaps cooperate to close the box and an inclined operating position displaced from the closed position. In the operating position, the ends of the flaps define a dispensing outlet spaced from the open side defined by the side wall or walls of the box. The dispensing outlet is smaller than the open side of the container such that as the sheet material is pulled from the box and through the dispensing outlet, the inclined flaps act as a forming member that inwardly gathers the sheet material, causing it to crumple as it is withdrawn from the box. Consequently, the present invention provides a dunnage system that efficiently stores a supply of stock material, and can be transformed to a configuration that facilitates converting the stock material into a relatively less dense dunnage product as it is dispensed from the box. In one embodiment, the flaps are movable between a generally planar closed position where the flaps cooperate to close the box and an inclined position displaced from the closed position and back again without any assembly or disassembly required.

More particularly, the present invention generally provides a dunnage system that includes a container having one or more flaps that are movable between a closed position that closes an open side of the container, and an operating position displaced from the closed position that defines an outlet opening having at least one dimension that is smaller than a corresponding dimension of the open side of the container. Preferably the outlet opening is narrower than the width of the open side of the container, where the open side of the container is defined by the side walls of the container and the width of the open side is substantially similar to the width of the sheet stock material for which the container is sized.

The present invention also provides a dunnage system for converting sheet stock material into a relatively less dense dunnage product that includes a container sized to contain a supply of sheet stock material. The container has a bottom wall, one or more side walls extending from respective edges of the bottom wall to define an enclosed space with an open side opposite the bottom wall, and one or more flaps extending from respective edges of the side walls opposite the bottom wall. The flaps are movable between a closed position that closes the open side of the container and an operating position displaced from the closed position that defines an outlet opening having at least one dimension that is smaller than a corresponding dimension of the open side of the container, whereby in the operating position the flaps inwardly gather and crumple sheet stock material pulled from the container through the outlet opening. The flaps may be held in a fixed relationship to one another, particularly in the operating position. The dunnage system also may include a supply of sheet stock material contained within the container, in the form of a fan-folded stack or a roll of sheet stock material, for example.

A disadvantage of some conversion machines is their width or the amount of space that they occupy, and in some situations it would be desirable to provide a narrower or smaller system for supplying stock material and converting it into a dunnage product. The present invention also provides a supply of stock material that includes a relatively wide sheet stock material within a narrower footprint.

More particularly, the present invention provides a supply of sheet stock material for conversion into a relatively less dense dunnage product. The supply includes a stack of fan-folded sheet stock material having a width dimension and fold lines generally parallel to the width dimension, and a container for receiving the stack. The container has a width dimension that is less than the width of the stack, whereby the stack is folded to fit within the container.

The present invention also provides a box having one or more flaps that are movable between a generally planar closed position where the flaps cooperate to close the box and an inclined operating position displaced from the closed position and back again, without any assembly or disassembly required.

In the operating position, the ends of the flaps define a dispensing outlet spaced from the open side, which is defined by the side wall or walls of the container. The dispensing outlet is smaller than the open side of the container such that as the sheet material is pulled from the container and through the dispensing outlet, the inclined flaps act as a forming member that inwardly gathers the sheet material, causing it to crumple as it is withdrawn from the container. The container also includes features that prevent the flaps from opening past the operating position. The flaps are restrained from rotating to a position aligned with the side walls of the container or beyond. To store the container again, the flaps can be pushed back to the closed position by pushing the flaps downward. This is made possible by the connection between adjacent flaps, which also provides the restraint. Thus the present invention provides a dunnage system that efficiently stores a supply of stock material, and can be transformed to a configuration that facilitates converting the stock material into a relatively less dense dunnage product as it is dispensed from the container.

Moreover, the container can be inverted and stock material can be withdrawn from an opposite side of the stack through an opening toward a bottom side of the container. This opening has approximately the same width as the stock material for withdrawing sheet material without crumpling.

More particularly, the present invention provides a dunnage system that includes a container for a supply of sheet stock material. The container has a width dimension that is substantially the same as the width dimension of the stock material, and an open side closed by one or more flaps in a substantially planar closed position or configuration. The flaps are movable to an operating position or configuration where the flaps are displaced from the closed position to form a outlet opening spaced from the open side of the container for dispensing crumpled stock material therethrough. The opening has a width dimension that is less than the width dimension of the container.

Other features provided by one or more embodiments of the invention include (a) a slot spaced from the open side of the container, the slot extending substantially parallel to the width dimension of the container for withdrawing uncrumpled stock material; (b) where in the operating position a distal end of the flap or flaps defines the outlet opening, which has at least one dimension that is smaller than a corresponding dimension of the open side of the container, whereby in the operating position the flaps inwardly gather and crumple sheet stock material pulled from the container through the outlet opening; (c) means for preventing the flaps from moving beyond the operating position, such as where at least one flap includes a tab portion that interlocks with a slot portion in another flap, where the slot portion is substantially longer than the tab portion to allow the flap to move between the substantially planar closed position and the operating position without removing the tab portion from the slot portion; (d) where each flap interlocks with an adjacent flap; (e) where the side walls of the container are perpendicular to the bottom wall, and when the flaps are in the closed position the flaps are perpendicular to the side walls; (f) where in the operating position the flaps define inclined converging walls; (g) where at least one flap has a non-linear slot to receive and hold a tab portion of another flap when the flaps are in the operating position; (h) where the flaps define a converging chute having a relatively larger inlet at the top of the side walls that is spaced from the outlet in the operating position, which is relatively smaller than the inlet; and/or (i) a supply of sheet stock material contained within the container, such as a fan-folded stack of sheet stock material, such as one or more plies of kraft paper.

The present invention also provides a packing method comprising the steps of (a) drawing sheet stock material through an opening in a container, the opening being smaller than the container, whereby the sheet stock material is crumpled as it is drawn through the opening; (b) inverting the container; and (c) drawing sheet stock material through a slot in the container having a width substantially equal to or greater than the width of the sheet stock material, whereby the sheet stock material remains uncrumpled as it is drawn through the slot.

The foregoing and other features of the invention are hereinafter fully described and particularly pointed out in the claims, the following description and annexed drawings setting forth in detail certain illustrative embodiments of the invention, these embodiments being indicative, however, of but a few of the various ways in which the principles of the invention may be employed.

### BRIEF DESCRIPTION OF THE DRAWINGS

FIG. 1 is a perspective side view of a dunnage system provided by the invention in operation with a supply of sheet stock material.

FIG. 2 is a perspective side view of the dunnage system of FIG. 1 in a compact, closed storage condition.

FIG. 3 is a perspective end view of the dunnage system of FIG. 1 in an open condition ready to receive a supply of sheet stock material.

FIG. 4 is a perspective side view of the dunnage system of FIG. 3.

FIG. 5 is a perspective end view of the dunnage system of FIG. 1 in an operating condition.

FIG. 6 is a perspective side view of the dunnage system of FIG. 5.

FIG. 7 is a perspective view of a stack of single-ply, fan-folded sheet stock material suitable for conversion into a dunnage product.

FIG. 8 is a perspective view of the stack of sheet stock material of FIG. 7 folded for insertion into a container in accordance with the invention.

FIG. 9 is a cross-sectional view of the folded stack of sheet stock material in a container in accordance with the invention.

FIG. 10 is a perspective view of a dunnage system provided in accordance with the invention with a front wall of the container displaced to show the folded stock material inside.

FIG. 11 is a perspective view of a dunnage system provided by the invention showing a container open to receive a supply of sheet stock material.

FIG. 12 is an enlarged view of a connecting feature between two flaps of the dunnage system of FIG. 11.

FIG. 13 is a perspective view of the dunnage system of FIG. 11 in a closed configuration.

FIG. 14 is a perspective view of the dunnage system of FIG. 13 in an operating configuration.

FIG. 15 is an enlarged view of a tab and slot arrangement in the operating configuration of FIG. 14.

FIG. 16 is an enlarged view of a tab and slot arrangement in the closed configuration of FIG. 13.

FIG. 17 is a perspective view of the dunnage system of FIG. 11, in an inverted configuration for withdrawing uncrumpled sheet material.

### DETAILED DESCRIPTION

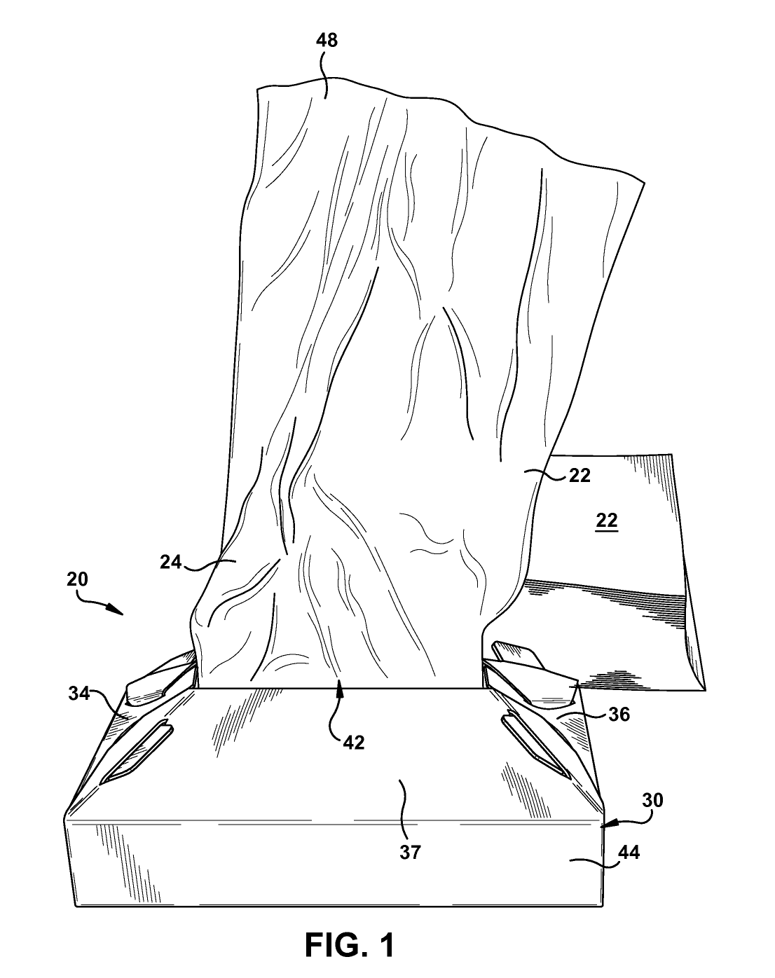

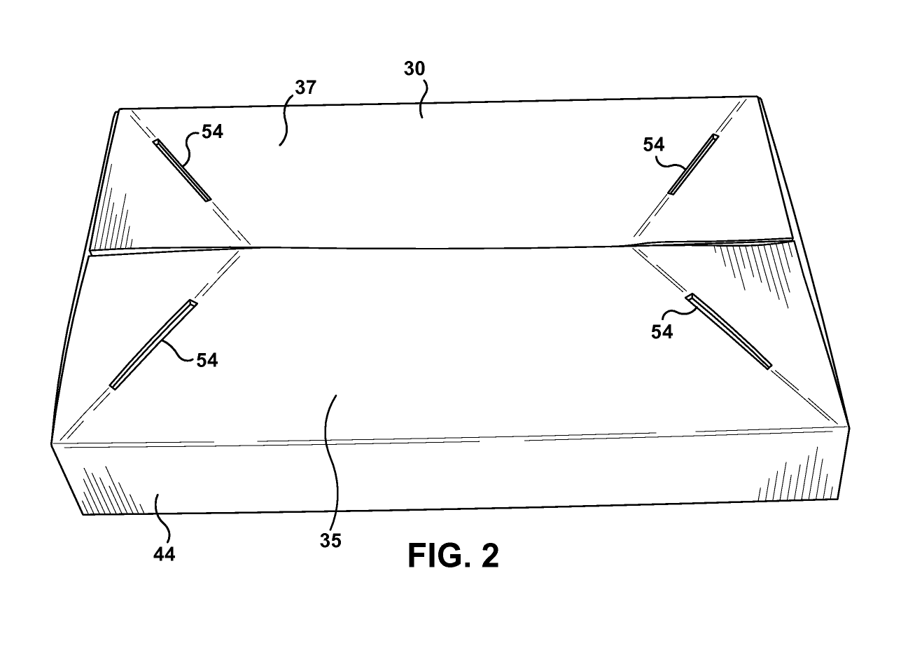

Referring now to the drawings in detail, the present invention generally provides a dunnage system 20 for converting a sheet stock material 22 into a relatively less dense dunnage product 24. The system 20 includes a box or container 30 having one or more flaps, in this case four flaps 34, 35, 36, and 37. The flaps 34, 35, 36, and 37 are movable between a closed position (FIG. 2) that closes an open side 40 of the container 30, and an operating position (FIG. 1) displaced from the closed position. In the operating position, the flaps 34, 35, 36, and 37 define an outlet opening 42 having at least one dimension that is smaller than a corresponding dimension of the open side 40 of the container 30. Preferably the outlet opening or outlet 42 is narrower than the width of the open side 40 of the container 30. The stock material generally is withdrawn from the container in a direction transverse the width dimension of the stock material. The open side 40 of the container 30 is defined by the side walls 44 of the container 30 and is opposite the back or bottom side 46 of the container 30.

Since transporting empty space to an end user is an inefficient use of resources, the length and width of the open side 40 is substantially similar to the corresponding length and width of the sheet stock material for which the container 30 is sized. When the system 20 includes a supply of sheet stock material 22 within the container 30, minimal or no open space should remain in the container 30.

The supply 132 includes one or more plies of sheet stock material 22, such as paper, and more particularly kraft paper. The stock material 22 can be provided in the form of a fan-folded stack, as shown, in the form of a roll or in the form of a stack of discrete sheets. If discrete sheets are used, the discrete sheets preferably are interleaved and of sufficient length such that pulling a leading sheet off the stack will draw a trailing sheet with it, one after the other. If one or more stock rolls are used, the stock roll or rolls can be supported in the container by suitable means for rotation so that the stock material can be paid off from the outside of the roll. In an alternative arrangement, the stock roll or rolls can be supported on one or more outer portions of the roll so that stock material can be withdrawn from the center or inside of the roll.

Regardless of the type or form of sheet stock material, preferably the stock material is perforated or otherwise weakened along longitudinally-spaced, transversely-extending tear lines to enable and/or facilitate separating discrete sections of dunnage from the crumpled strip.

The container 30 in the illustrated embodiment has a rectangular shape, but other container shapes are possible. Generally, the container 30 should closely approximate the shape of the supply of stock material to minimize empty space in the container. An exemplary container 30 is made of cardboard, but any material that allows the container 30 to function in the manner described would suffice.

The side wall or walls 44 of the container 30 extend from respective edges of the bottom wall 46 to define an enclosed space with an open side 40 opposite the bottom wall 46. The one or more flaps 34, 35, 36, and 37 are hingedly connected to respective edges of the side walls 44 opposite the bottom wall 46. Each flap 34, 35, 36, and 37 has a substantially planar shape and extends from a respective side wall 44 that is perpendicular to an adjacent side wall 44. The side walls 44 are perpendicular to the bottom wall 46. When the flaps 34, 35, 36, and 37 are in the closed position, the flaps 34, 35, 36, and 37 are generally in the same plane or parallel to one another, and perpendicular to the side walls 44.

In the operating position, the flaps 34, 35, 36, and 37 define inclined converging walls that inwardly gather and crumple sheet stock material 22 pulled from the container 20 through the outlet opening 42. In other words, in the operating position the flaps 34, 35, 36, and 37 define a converging chute having a relatively larger inlet at the top of the side walls 44 that is spaced from the outlet 42, which is relatively smaller than the inlet.

Not only does the outlet opening 42 have a relatively smaller area, the outlet generally has a width that is less than the width of the open side 40 of the container 30. The width of the open side 40 of the container 30 typically closely corresponds to the width of the sheet material, such that the width of the outlet is less than the width of the sheet material.

To ensure that the flaps 34, 35, 36, and 37 will force lateral portions of the sheet material 22 (FIG. 1) inward, the illustrated container 30 also includes means for securing the flaps 34, 35, 36, and 37 in the operating position. The securing means includes one or more of chemical elements, such as an adhesive or an adhesive tape; and mechanical elements, such as a strap, cooperating elements of respective flaps, magnets, straps, hook-and-loop fasteners, snaps, pins, etc. that help to catch and hold the flaps in a fixed relationship to one another so that the flaps do not move as the stock material is withdrawn through the outlet 42. Although a variety of securing means will be apparent to the skilled person, one example is shown in the accompanying drawings.

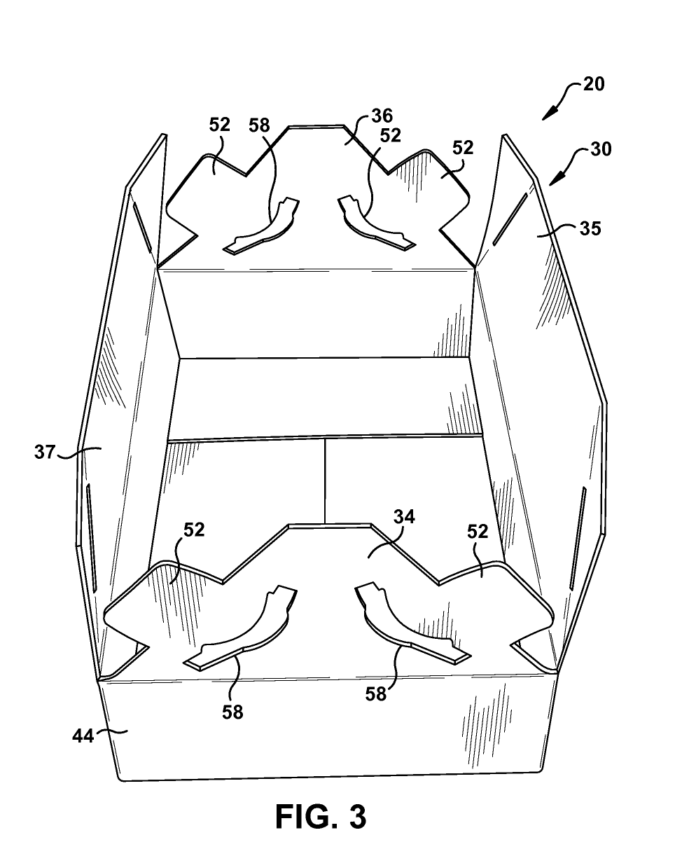

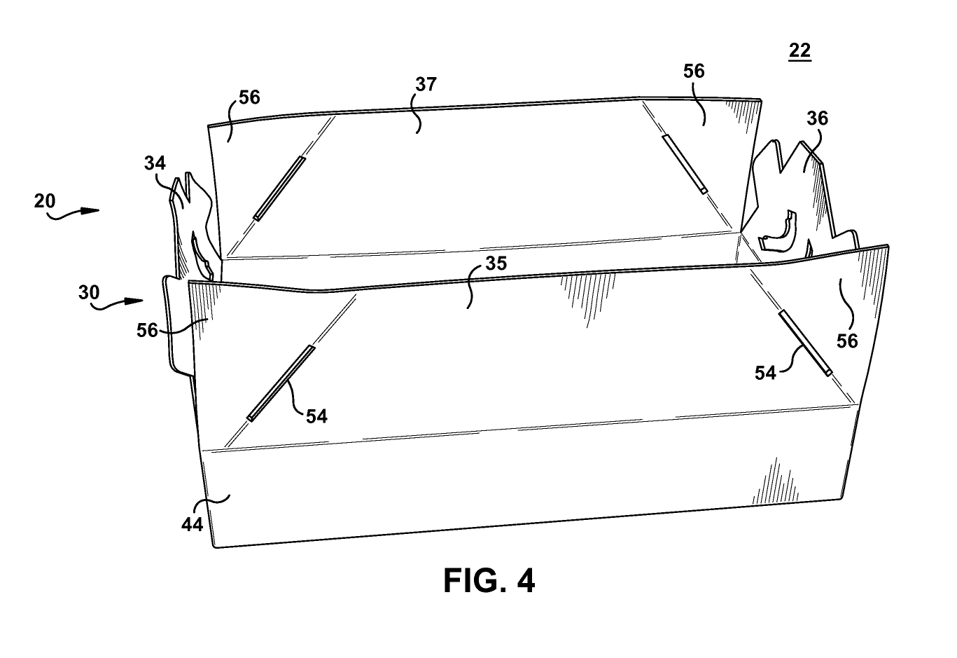

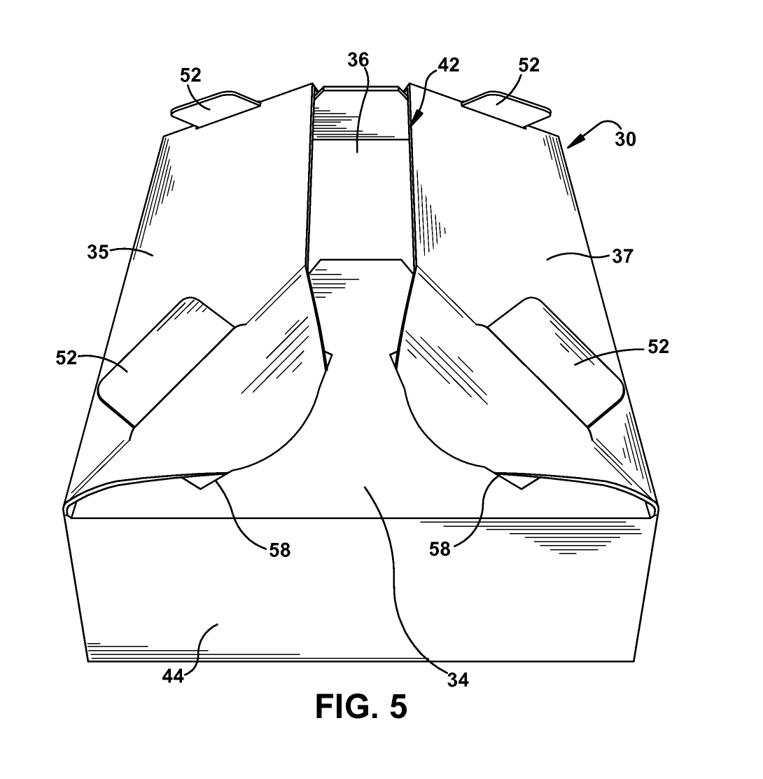

In this embodiment, a tab-and-slot arrangement is used to hold the flaps 34, 35, 36, and 37 in the operating position. At least one flap includes a tab portion that interlocks with a slot portion in another flap to hold the flaps together as sheet material is drawn from the outlet 42. As shown in FIGS. 3 and 4, the flaps 34, 35, 36, and 37 include four flaps arranged in two pairs, one pair of relatively longer rectangular flaps 35 and 37 and one pair of relatively shorter flaps 34 and 36. The shorter flaps 34 and 36 in this embodiment have a tapered or truncated triangular shape. Each pair of flaps 34 and 36, and 35 and 37, extend from parallel side walls in the illustrated embodiment. The tapered edges of the shorter flaps 34 and 36 correspond to the inclined state of the longer flaps 35 and 37 in the operating position.

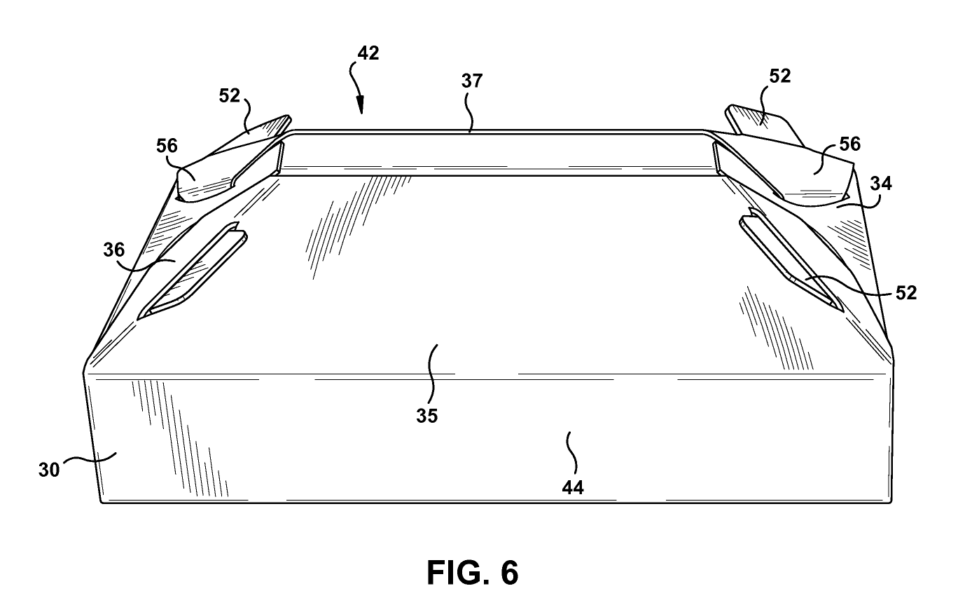

In this embodiment, ears or tabs 52 extend from the inclined edges of the shorter flaps 34 and 36, and are received in inclined slots 54 in the longer flaps 35 and 37. The tabs 52 can be shorter than shown or arranged in a different manner so that they do not stand proud of the longer flaps 35 and 37. Additionally, corners 56 of the longer flaps 35 and 37 also can function as tab portions or tabs that can be received in curved slots 58 in the shorter flaps 34 and 36. The curved nature of the slots 58 and the relatively planar natural state of the flaps 35 and 37 helps the curved slots 58 hold the corners 56 in place, as shown in FIG. 6. Other nonlinearly-shaped slots alternatively may be employed to receive tabs and to hold the flaps 34, 35, 36, and 37 in the operating position. Thus, in the operating position each flap 34, 35, 36, and 37 interlocks with an adjacent flap. Although friction alone should be sufficient to hold the flaps 34, 35, 36, and 37 in place, an adhesive or other fastener can be used to further hold the flaps 34, 35, 36, and 37 in the operating position. The inclined and interlocked flaps 34, 35, 36, and 37 give the container 30 the appearance of a building with a hip-type roof.

Once the flaps 34, 35, 36, and 37 are arranged in the operating position, distal edges of one or more of the flaps 34, 35, 36, and 37 define the outlet opening 42 and space the outlet opening 42 from the opening at the open side 40 of the container 30. Although four flaps 34, 35, 36, and 37 define the outlet 42 in the illustrated embodiment, only one flap or two flaps may define the outlet opening 42 in other embodiments provided by the invention.

The illustrated container 30 (FIG. 2) is substantially rectangular, which facilitates stacking multiple containers in a compact configuration one on top of another and closely adjacent one another for efficient shipment to end users. The container 30 is reconfigurable or transformable from its compact shipping configuration with the flaps 34, 35, 36, and 37 in the closed position, to a less compact converting configuration with the flaps 34, 35, 36, and 37 in the operating position.

In use, the flaps 34, 35, 36, and 37 are moved to the operating position (FIG. 1) and secured in place relative to one another. Then the packer reaches into the container 30 and pulls out the leading end 48 of the supply of sheet stock material, which is fan-folded kraft paper in FIG. 1. As this is done, the sheet stock material 22 will be gathered and circumferentially progressively crumpled as it moves through the narrowing space defined by the inclined flaps 34, 35, 36, and 37 and out the dispensing outlet 42. The packer generally will pull the sheet material 22 out the dispensing outlet 42 hand-over-hand, forming a strip of void-fill dunnage product 24 in the process.

As the packer pulls the sheet material 22 between the converging flaps 34, 35, 36, and 37 and out the dispensing outlet 42, the packer generally will grasp the strip at spaced locations along the length of the strip, thereby helping to crease folds in the crumpled strip and thus help the crumpled strip retain its crumpled, relatively low-density, state. When a desired amount of dunnage 24 has been pulled from the container 30 the packer can tear, cut or otherwise separate a section of the dunnage strip for use in packing one or more articles in a shipping carton or the like to minimize movement of the articles during shipment.

In summary, the present invention provides a self-contained dunnage system 20 in a box that weighs little more than the stock material itself. The self-contained dunnage system 20 includes a box or other container 30 sized to receive a supply of sheet stock material 22 with minimal or no empty space when the box 30 is closed.

The box 30 has one or more flaps 34, 35, 36, and 37 that are movable between (i) a generally planar closed position (FIG. 2) where the flaps 34, 35, 36, and 37 cooperate to close the box 30, and (ii) an inclined operating position (FIG. 6) displaced from the closed position. In the operating position, the ends of the flaps 34, 35, 36, and 37 define a dispensing outlet 42 spaced from an open side 40 of the box 30. The open side 40 of the box 30 generally is defined by the side wall or walls 44 of the box 30. The dispensing outlet 42 is smaller than the open side 40 of the box 30. As the sheet material is pulled from the box 30 and through the outlet 42, the inclined flaps 34, 35, 36, and 37 act as a forming member that inwardly gathers the sheet material, causing it to crumple as it is withdrawn from the box 30.

Thus the present invention provides a dunnage system 20 that efficiently stores a supply of stock material 22 when closed, and can be transformed to a configuration that facilitates converting the stock material 22 into a relatively less dense dunnage product 24 as it is dispensed from the box 30.

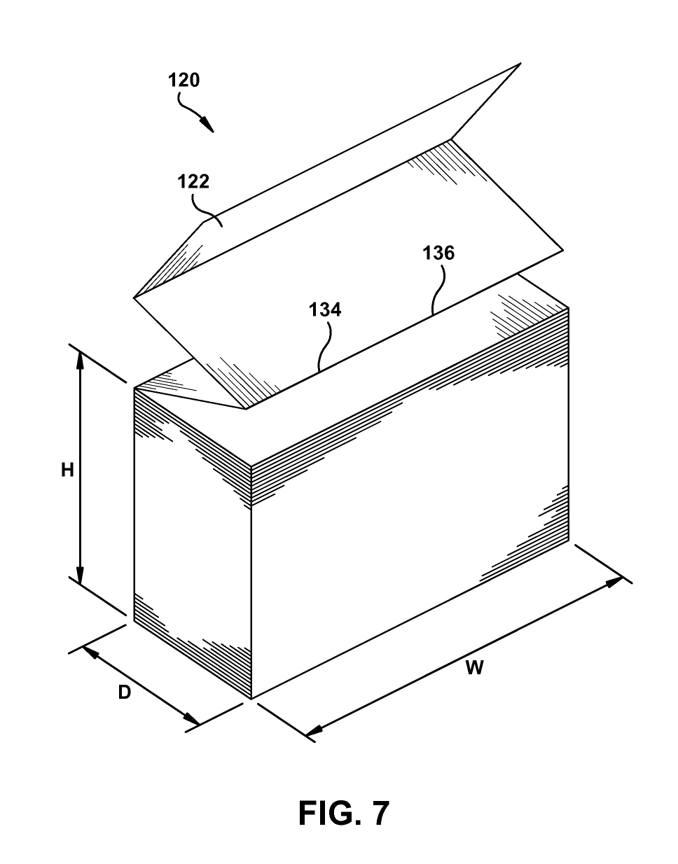

The present invention also proves an alternative configuration for the fan-folded sheet stock material. Rather than a flat stack of sheet stock material 22 as shown in FIG. 1, the stack of sheet stock material 120 can be folded or bent as shown in FIGS. 7-10.

Accordingly, the present invention provides a supply 120 (FIG. 7) of sheet stock material 122 (FIG. 7) for conversion into a relatively less-dense dunnage product 124 (FIG. 10) in a manner similar to that described above. The supply 120 includes a stack 122 of fan-folded sheet stock material and a container 126 for receiving the stack 122. The supply 120 provides a relatively wide sheet stock material 122 within a narrower footprint, reducing or eliminating the need to form the sheet material as it is pulled from the supply 20.

The stack 122 preferably includes one or more plies of sheet stock material, such as paper, and more particularly kraft paper. The stack 122 has a width dimension W, a depth dimension D, and a height dimension H. The sheet stock material 122 also has fold lines 134 generally parallel to the width dimension W. The stock material also preferably is perforated or otherwise weakened along longitudinally-spaced, transversely-extending tear lines 136 to enable and/or facilitate separating discrete sections of dunnage from the crumpled strip. The tear lines generally are coextensive with the fold lines 134. This is substantially the same stock material 22 (FIG. 1) described above.

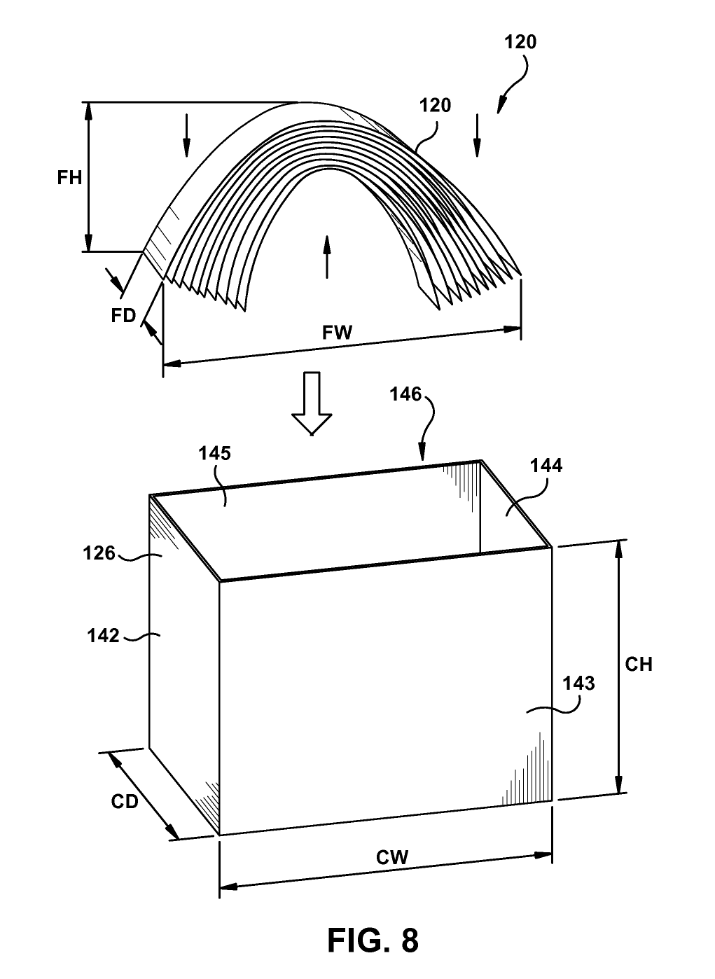

As shown in FIG. 8, the container 126 has a width dimension CW that is less than the width dimension W of the stack 122, whereby the stack 122 must be folded to fit within the container 126. The stack 122 of sheet stock material is folded about an axis that is transverse the width dimension W. The stack 122 is folded such that the ends 138 of the stack move downward relative to an upwardly moving central portion 139 to form an inverted-U shape. The resulting folded stack 122 has a folded width dimension FW that is less than the unfolded width dimension W, a folded height dimension FH that is greater than the unfolded height dimension H, and a folded depth dimension FD that is the same as the unfolded depth dimension D. The container 126 also has a height dimension CH and a depth dimension CD. The container height dimension CH and the container depth dimension generally correspond to the folded height dimension FH and the folded depth dimension FD, respectively, of the stack 122.

The illustrated container 126 has a bottom wall 140 (FIG. 10), one or more side walls 142, 143, 144, and 145 extending from respective edges of the bottom wall 140 to define an enclosed space with an open side 146 opposite the bottom wall 140. The front 143 and rear 145 side walls can be omitted, but the left 142 and right 144 side walls hold the folded stack 122 in its folded state. The container 122 may further include one or more flaps hingedly connected to respective edges of the side walls opposite the bottom wall to close the open side 146 for shipment or storage. The flaps also may be provided with means for holding the flaps in the operating position, as described in connection with the preceding embodiment.

The container 126 in the illustrated embodiment has a rectangular shape, but other container shapes are possible. A rectangular container 126 facilitates stacking multiple containers in a compact configuration one on top of another and closely adjacent one another for efficient shipment to end users. An exemplary container 126 is made of cardboard, but any material that allows the container to function in the manner described would suffice.

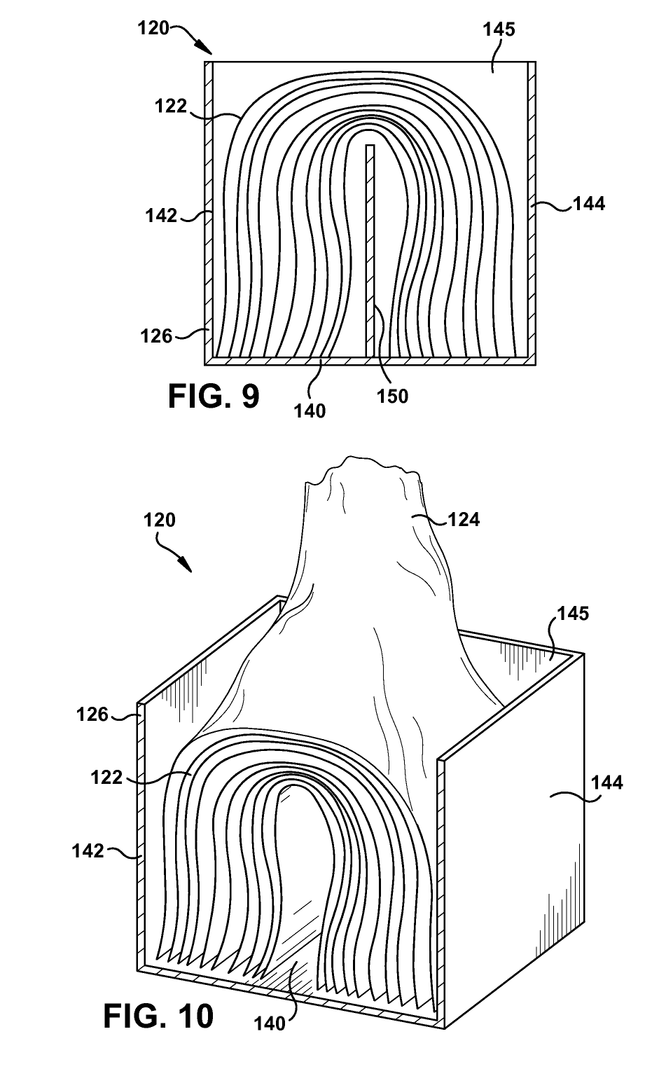

Another exemplary container 126 is shown in section in FIG. 9. This container 126 includes a central rib 150 extending into the container from the bottom wall 140. The stack 122 is folded over the rib 150, which helps the stack 122 remain in its folded state. The height of the rib 150 can vary based on the degree of fold desired in the stack 122.

The supply 120 in FIG. 10 illustrates how the stock material crumples as it is pulled from the folded stack 122. This embodiment does not include a central rib in the container 126; the side walls of the container hold the stack 122 in its folded state. Consequently, the front wall 143 (FIG. 8) of the container has been omitted, which facilitates reloading the container 126 with a folded stack 122 of sheet stock material. The crumpled dunnage product 124 pulled from the stack 122 is ready for use by a packer.

As the supply of paper nears depletion, its weight may decrease until the action of withdrawing the paper may cause the container to lift off its support surface. To overcome and to prevent this problem, the container may be secured with straps, adhesive tape, hook-and-loop patterns, etc., between the bottom side and the support surface, such as a table top.

The present invention also provides a self-contained dunnage system with a container sized to receive a supply of sheet stock material, where the container has multiple interconnected flaps that are movable between a closed position and an operating position, and back again, without any assembly or disassembly. In the closed position the flaps cooperate to close the container with minimal or no empty space in the container, and in the operating position displaced from the closed position the flaps define a dispensing outlet. The dispensing outlet is smaller than the open side of the container such that as the sheet material is pulled through the outlet, the inclined flaps inwardly gather the sheet material, causing it to crumple as it is withdrawn. The crumpled dunnage product can be used for filling voids in a shipping container.

The container provided by the invention also can be inverted and stock material withdrawn through a slot toward a bottom side of the container. The slot is sized for withdrawing sheet material without crumpling, for use in layering in a shipping container or wrapping an article for shipment. Thus the present invention provides a dunnage system that efficiently stores a supply of stock material, and can be transformed to a configuration that facilitates converting the stock material into a relatively less dense dunnage product as it is dispensed from the box while also providing the ability to dispense an uncrumpled sheet product.

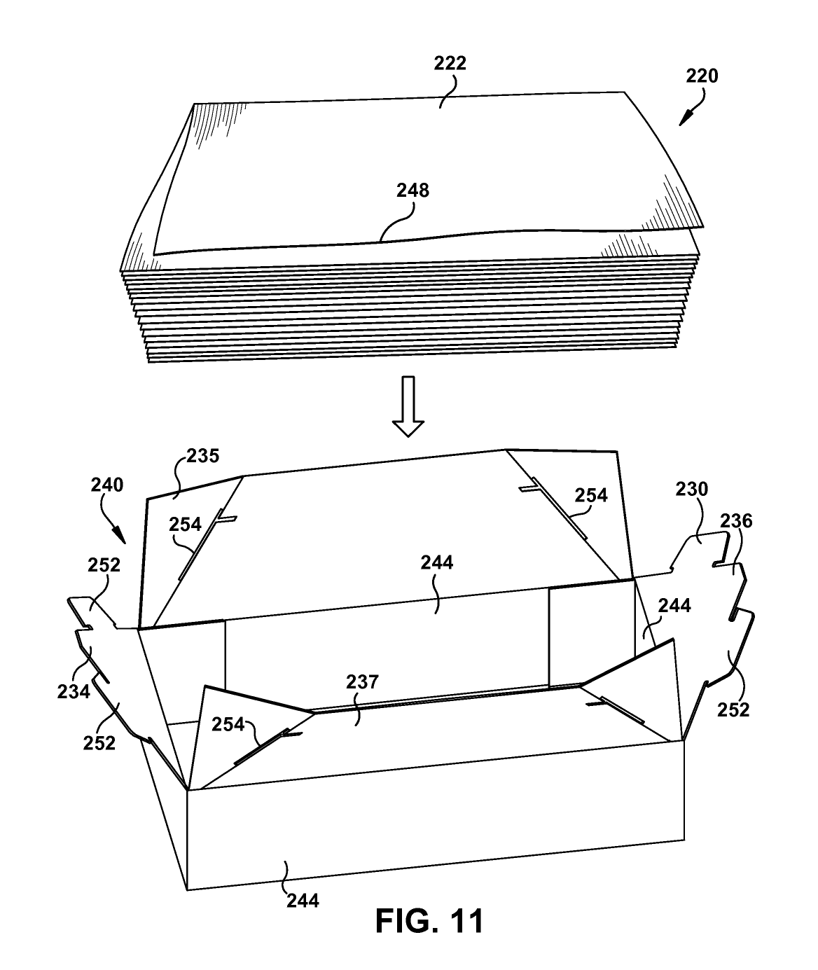

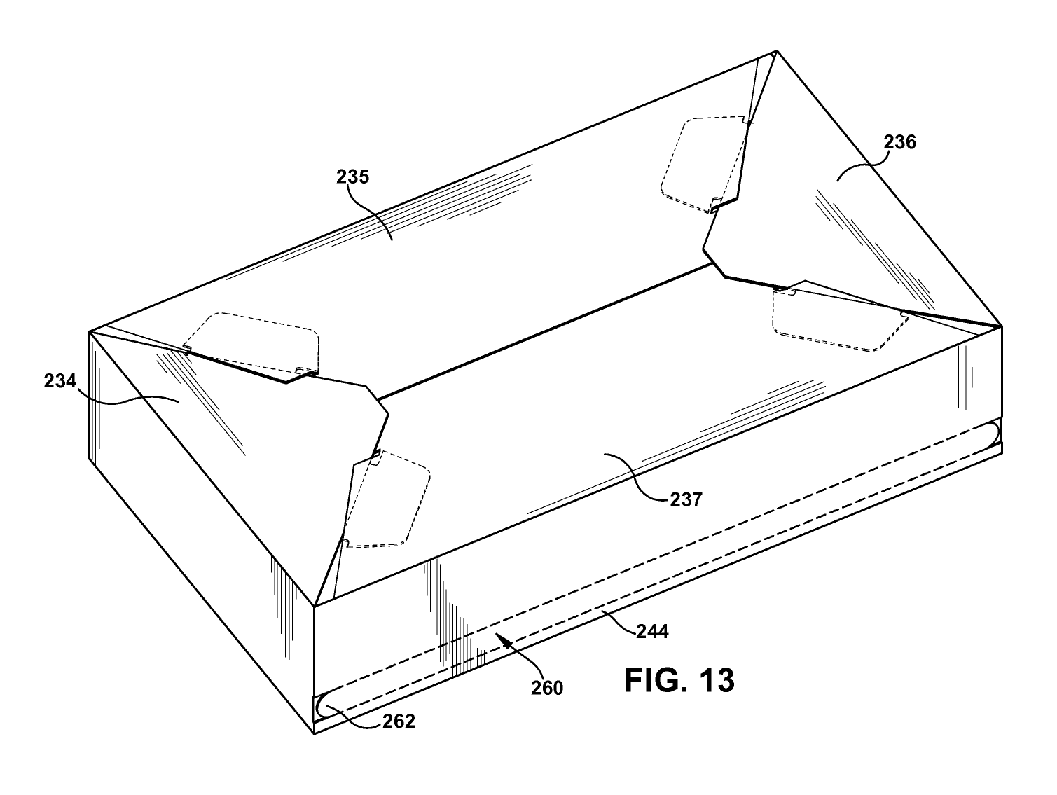

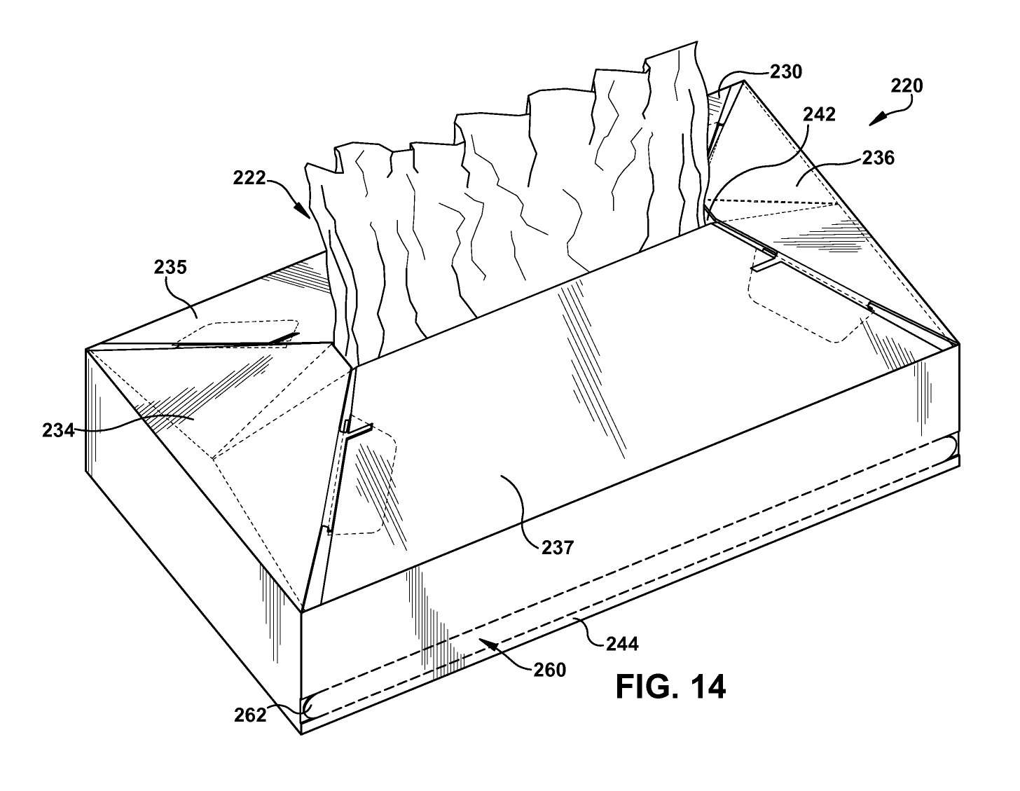

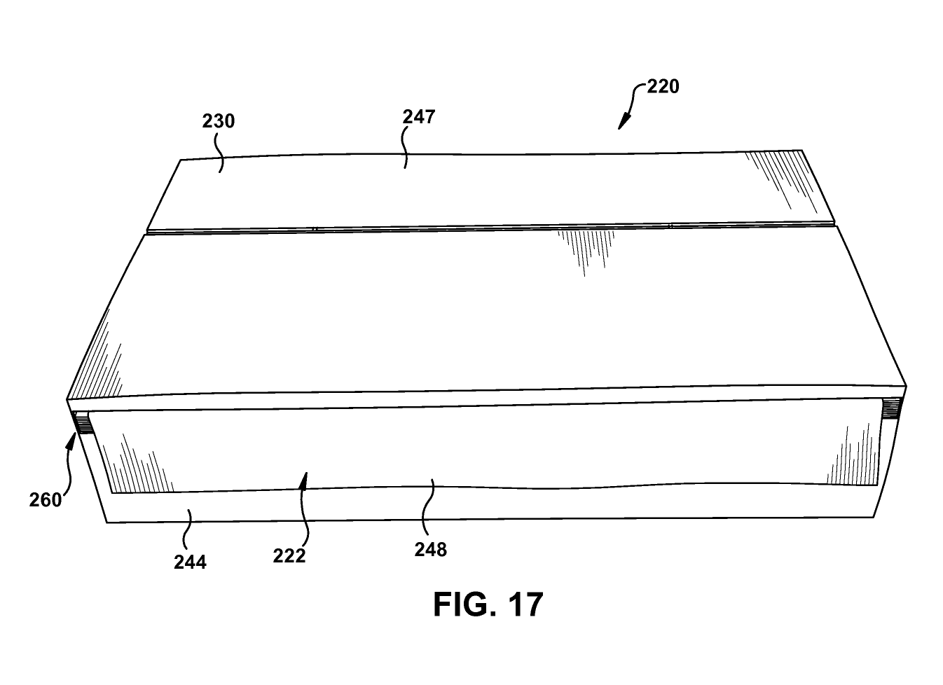

Referring now to FIGS. 11-17 in detail, the present invention also provides another dunnage system 220 for converting a sheet stock material 222 into a relatively less dense dunnage product 224 (FIG. 14). The system 220 includes a box or container 230 having one or more flaps, in this case four flaps, 234, 235, 236, and 237, that are movable between a closed position (FIG. 13) that closes an open side 240 of the container 230, and an operating position (FIG. 14) displaced from the closed position that defines an outlet opening 242 (FIG. 14) having at least one dimension that is smaller than a corresponding dimension of the open side 240 of the container 230. Preferably the outlet opening or outlet 242 is narrower than the width of the open side 240 of the container, where the open side 240 of the container 230 is defined by the side walls 244 of the container 230 and is opposite the back or bottom side 246 (FIG. 17) of the container 230.

Since transporting empty space to an end user is an inefficient use of resources, the length and width of the open side 240 is substantially similar to the corresponding length and width of the sheet stock material 222 for which the container 230 is sized. As a result, when the system 220 includes a supply of sheet stock material 222 within the container 230, minimal or no open space should remain in the container 230.

The supply includes one or more plies of sheet stock material 222, such as paper, and more particularly kraft paper. The stock material 222 can be provided in the form of a fan-folded stack, as shown, in the form of a roll or in the form of a stack of discrete sheets. If discrete sheets are used, the discrete sheets preferably are interleaved and of sufficient length such that pulling a leading sheet off the stack will draw a trailing sheet with it, one after the other. If one or more stock rolls are used, the stock roll or rolls can be supported in the container by suitable means for rotation so that the stock material can be paid off from the outside of the roll. In an alternative arrangement, the stock roll or rolls can be supported on one or more outer portions of the roll so that stock material can be withdrawn from the center or inside of the roll.

Regardless of the type of stock material, preferably the stock material is perforated or otherwise weakened along longitudinally-spaced, transversely-extending tear lines to enable and/or facilitate separating discrete sections of dunnage from the remaining stock material.

The illustrated container 230 has a bottom wall 246 (FIG. 17), one or more side walls 244 extending from respective edges of the bottom wall 246 to define an enclosed space with an open side 240 opposite the bottom wall 246, and one or more flaps 234, 235, 236, and 237 hingedly connected to respective edges of the side walls 244 opposite the bottom wall 246. The container 230 in the illustrated embodiment has a rectangular shape, but other container shapes are possible. Generally, the container 230 should closely approximate the shape of the supply of stock material to minimize empty space in the container. Each flap 234, 235, 236, and 237 has a substantially planar shape and extends from a respective side wall 244 that is perpendicular to an adjacent side wall 244. The side walls 244 are perpendicular to the bottom wall 246, and when the flaps 234, 235, 236, and 237 are in the closed position (FIG. 13) the flaps 234, 235, 236, and 237 are generally in the same plane or parallel to one another, and perpendicular to the side walls 244. An exemplary container 230 is made of cardboard, but any material that allows the container 230 to function in the manner described would suffice.

The flaps 234, 235, 236, and 237 are movable between the closed position (FIG. 13) that closes the open side 240 of the container 230 and the operating position (FIG. 14) displaced from the closed position that defines a substantially rectangular outlet opening or dispensing outlet 242 having at least one dimension that is smaller than a corresponding dimension of the open side 240 of the container 230. In the operating position, the flaps 234, 235, 236, and 237 define inclined converging walls that inwardly gather and crumple sheet stock material 222 pulled from the container 220 through the outlet opening 242. In other words, in the operating position the flaps 234, 235, 236, and 237 define a converging chute having a relatively larger inlet at the top of the side walls 244 that is spaced from the outlet 242, which is relatively smaller than the inlet.

Not only does the outlet opening 242 have a relatively smaller area, the outlet generally has a width that is less than the width of the open side 240 of the container 230. The width of the open side 240 of the container 230 preferably closely corresponds to the width of the sheet material, such that the width of the outlet is less than the width of the sheet material.

To ensure that the flaps 234, 235, 236, and 237 will force lateral portions of the sheet material 222 (FIG. 11) inward, the illustrated container 230 also includes means for connecting adjacent flaps and preventing the flaps 234, 235, 236, and 237 from opening beyond the operating position. The connecting and preventing means includes one or more of chemical elements, such as an adhesive or an adhesive tape; and mechanical elements, such as a strap, cooperating elements of respective flaps, magnets, straps, hook-and-loop fasteners, snaps, pins, etc. that help to catch and hold the flaps connected to one another so that the flaps do not move beyond the operating position as the stock material is withdrawn through the outlet 242. Although a variety of securing means will be apparent to the skilled person, one example is shown in the accompanying drawings.

In this embodiment, a tab-and-slot arrangement is used to interconnect the flaps 234, 235, 236, and 237. At least one flap includes a tab portion that interlocks with a slot portion in another flap to hold the flaps together. The flaps 234, 235, 236, and 237 include four flaps arranged in two pairs, one pair of relatively longer rectangular flaps 235 and 237 and one pair of relatively shorter flaps 234 and 236 that have a tapered or truncated triangular shape. Each pair of flaps 234 and 236, and 235 and 237, extend from parallel side walls in the illustrated embodiment.

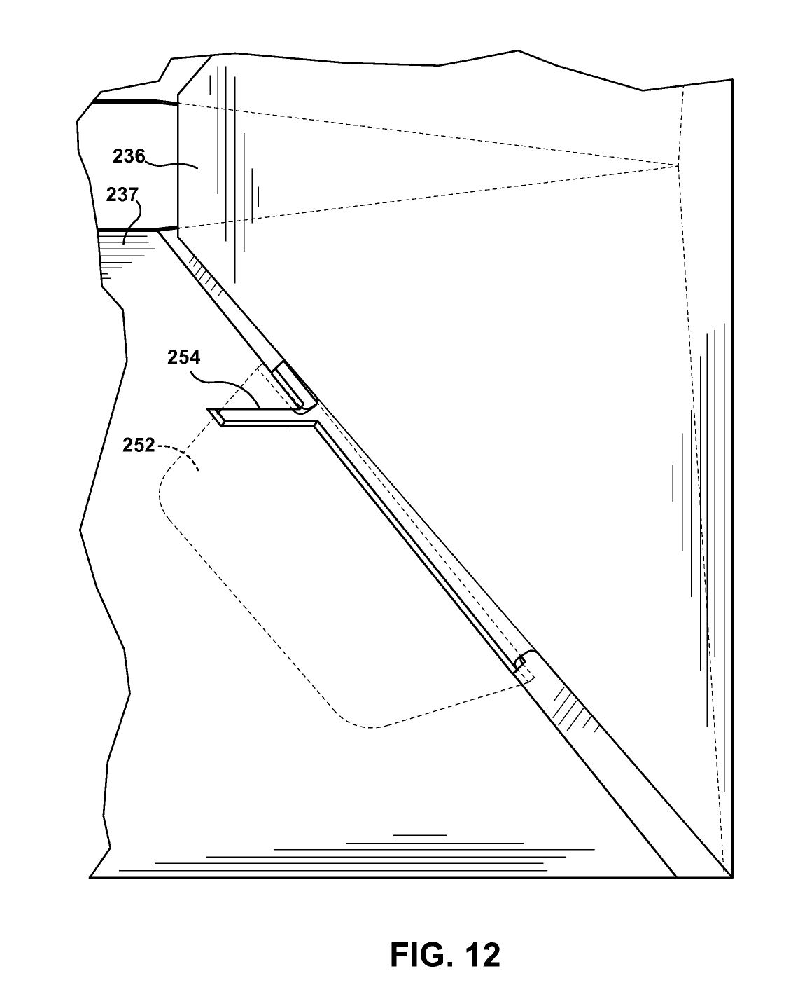

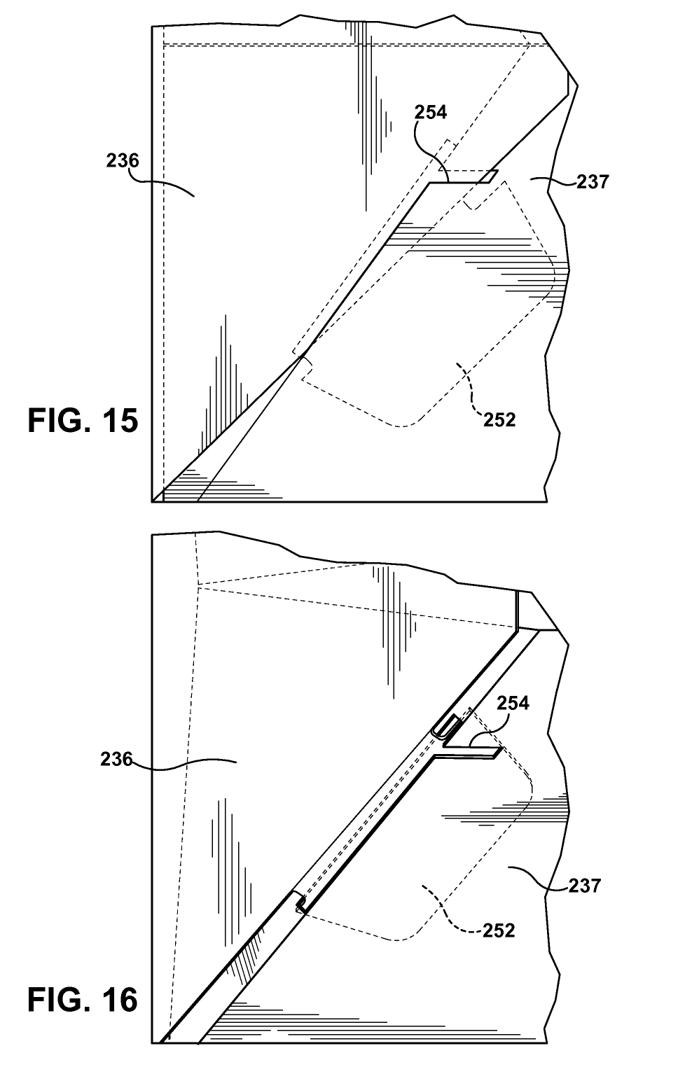

Ears or tabs 252 extend from the inclined edges of the shorter flaps 234 and 236, and are received in inclined slots 254 in the longer flaps 235 and 237. The slots 254 have two linear sections, a main portion and an extension portion at one end that extends away from the main portion, similar to the shape of a hockey stick. The extension portion makes it easier to assemble the tabs 252 in the slots 254, as shown in FIG. 12. The tabs 252 and slots 254 interlock each flap 234, 235, 236, and 237 with an adjacent flap. The slots 254 are longer than the portions of the tabs 252 that connect the tabs 252 to corresponding flaps. This allows the tabs 252 to slide along the length of the main portion of the slots 254 as the flaps 234, 235, 236, and 237 move back and forth between the closed position and the operating position. This concept is further illustrated in FIGS. 15 and 16. In FIG. 15, the tab 252 and slot 254 are shown in an arrangement corresponding to the operating position, and in FIG. 16 the tab 252 and slot are shown in an arrangement corresponding to the closed position.

When the flaps 234, 235, 236, and 237 are arranged in the operating position, distal edges of one or more of the flaps 234, 235, 236, and 237 define the outlet opening 242 and space the outlet opening 242 from the opening at the open side 240 of the container 230. As shown in FIG. 14, in the operating position the inclined and interlocked flaps 234, 235, 236, and 237 give the container 230 the appearance of a building with a hip roof. Although four flaps 234, 235, 236, and 237 define the outlet 242 in the illustrated embodiment, other numbers of flaps may define the outlet opening 242 in other embodiments provided by the invention.

The illustrated container 230 is substantially rectangular, which facilitates stacking multiple containers in a compact configuration one on top of another and closely adjacent one another for efficient shipment to end users. The container 230 is reconfigurable or transformable from its compact shipping configuration with the flaps 234, 235, 236, and 237 in the closed position, to a less compact converting configuration with the flaps 234, 235, 236, and 237 in the operating position without the end user having to assemble the tabs 252 in the slots 254. Likewise, the container 30 can be reconfigured from by moving the flaps 234, 235, 236, and 237 from the operating position to the more compact closed position without disassembling the tabs 252 from the slots 254.

In use, the flaps 234, 235, 236, and 237 are moved to the operating position, and the packer reaches into the container 230 and pulls out the leading end 248 of the supply of sheet stock material, such as fan-folded kraft paper. As this is done, the sheet stock material 222 will be gathered and circumferentially progressively crumpled as it moves through the narrowing space defined by the inclined flaps 234, 235, 236, and 237 and out the dispensing outlet 242. The packer generally will pull the sheet material 222 out the dispensing outlet 242 hand-over-hand, forming a strip of void-fill dunnage product 224 in the process. As the packer pulls the sheet material 222 between the converging flaps 234, 235, 236, and 237 and out the dispensing outlet 42, the packer generally will grasp the strip at spaced locations along the length of the strip, thereby helping to crease folds in the crumpled strip and thus help the crumpled strip retain its crumpled, relatively low-density, state. When a desired amount of dunnage 224 has been pulled from the container 30 the packer can tear, cut or otherwise separate a section of the dunnage strip for use in packing one or more articles in a shipping carton or the like to minimize movement of the articles during shipment.

In the illustrated embodiment, the container 230 also has a slot 260 in a side wall that is substantially the same width as the sheet stock material to allow stock material to be withdrawn from the supply without crumpling. In the embodiment illustrated in FIG. 13 the slot 260 is closed by a pull-tab 262 during shipment and until ready for use. The pull-tab 262 is integrally formed in the side wall of the container 230 by perforating the container 230 along parallel, spaced lines. Removing the pull-tab 262 creates the slot 260, as shown in FIG. 17. The slot 260 normally is provided toward a bottom wall 246 of the container 230 so that the container can be inverted and sheet stock material can be drawn through the slot 260 from what was the bottom of the stack of sheet stock material 222 for use as a relatively uncrumpled protective wrapping material. Then the container 230 can be re-inverted and crumpled stock material can once again be drawn through the outlet opening 242 as void-filling dunnage.

In summary, the present invention provides a self-contained dunnage system 220 in a box that weighs little more than the stock material itself. The self-contained dunnage system 220 includes a box or other container 230 sized to receive a supply of sheet stock material 222 with minimal or no empty space when the box 230 is closed. The box 230 has one or more flaps 234, 235, 236, and 237 that are movable between a generally planar closed position (FIG. 13) where the flaps 234, 235, 236, and 237 cooperate to close the box 230 and an inclined operating position (FIG. 14) displaced from the closed position. In the operating position, the ends of the flaps 234, 235, 236, and 237 define a dispensing outlet 242 spaced from an open side 240 of the box 230 defined by the side wall or walls 244 of the box 230. The dispensing outlet 242 is smaller than the open side 240 of the box 230 such that as the sheet material is pulled from the box 230 and through the outlet 242, the inclined flaps 234, 235, 236, and 237 act as a forming member that inwardly gathers the sheet material, causing it to crumple as it is withdrawn from the box 230. Thus the present invention provides a dunnage system 220 that efficiently stores a supply of stock material 222 when closed, and can be transformed to a configuration that facilitates converting the stock material 222 into a relatively less dense dunnage product 224 as it is dispensed from the box 230.

Moreover, in addition to drawing sheet stock material 222 through the outlet opening 242 to crumple the stock material as it is drawn through the opening, the present invention provides that by inverting the container 230 sheet stock material 222 can be drawn from an opposite side of the stack of sheet stock material without disassembling sheet stock material from the dispensing outlet to feed it through the slot 260. Stock material drawn through the slot 260, which has a width substantially equal to or greater than the width of the sheet stock material 222, remains uncrumpled as it is drawn through the slot 260. The container 230 can then be re-inverted to return to drawing crumpled stock material from the dispensing outlet 242.

Thus, the present invention provides a self-contained dunnage system that includes a container sized to receive a supply of sheet stock material. The container has multiple interconnected flaps that are movable between a closed position and an operating position without any assembly or disassembly. In the closed position the flaps cooperate to close the container with minimal or no empty space in the container, and in the operating position displaced from the closed position where the flaps define a dispensing outlet. The dispensing outlet is smaller than the open side of the container such that as the sheet material is pulled through the outlet, the inclined flaps inwardly gather the sheet material, causing it to crumple as it is withdrawn. The container also can be inverted and stock material withdrawn through a slot toward a bottom side of the container. The slot is sized for withdrawing sheet material without crumpling.

Accordingly, these supplies of sheet stock material enable the use of a relatively wide stock material to produce dunnage products having advantages in relatively high density and volume that would otherwise generally would not be possible from a narrower stock material. Drawing sheet stock material from a folded stack also reduces or eliminates the need to form the stock material as it is pulled through a dunnage conversion machine, thereby reducing the size of the converting system.

The present invention thus provides a self-contained dunnage system 20 referring to (FIGS. 1 and 2) that includes a box 30 sized to receive a supply of sheet stock material with minimal or no empty space when the box 30 is closed. The box 30 has one or more flaps 34, 35, 36, 37 that are movable between a generally planar closed position (FIG. 2) where the flaps cooperate to close the box 30 and an inclined operating position (FIG. 1) displaced from the closed position. In the operating position, the ends of the flaps 34, 35, 36, 37 define a dispensing outlet 42 spaced from an open side of the box 30 defined by the side wall or walls 44 of the box 30. The dispensing outlet 42 is smaller than the open side of the box 30 such that as the sheet material is pulled from the box 30 and through the outlet 42, the inclined flaps 34, 35, 36, 37 act as a forming member that inwardly gathers the sheet material, causing it to crumple as it is withdrawn from the box 30.

Although the invention has been shown and described with respect to a certain illustrated embodiment or embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiment or embodiments of the invention.

In summary, the present invention provides one or more of the features described in the following clauses:

A. A dunnage system, comprising a container for receiving a stock material, the container having at least one movable flap that is movable between a closed position where the flap at least partially closes an open side of the container, and an operating position outwardly displaced from the closed position, where when the movable flap is in the operating position the movable flap defines a side of an outlet opening having at least one dimension that is smaller than a corresponding dimension of the open side of the container.

B. A system as set forth in clause A, where the container is sized to contain a supply of sheet stock material, the container having a bottom wall, one or more side walls extending from respective edges of the bottom wall to define an enclosed space with an open side opposite the bottom wall, and multiple flaps that extend from respective edges of the side walls opposite the bottom wall;

where the flaps define a converging chute having a relatively larger inlet at the top of the side walls that is spaced from the outlet opening, which is relatively smaller than the inlet; and

where, in the operating position, the flaps inwardly gather and crumple sheet stock material pulled from the container through the outlet opening.

C. A system as set forth in clause A or any other clause, where in the operating position a distal end of the flap or flaps defines the outlet opening, which has at least one dimension that is smaller than a corresponding dimension of the open side of the container, whereby in the operating position the flaps inwardly gather and crumple sheet stock material pulled from the container through the outlet opening.

D. A system as set forth in clause B or any other clause, comprising means for securing the flaps in the operating position.

E. A system as set forth in clause A or any other clause, comprising means for preventing the flaps from moving beyond the operating position.

F. A system as set forth in clause B or any other clause, where in the operating position each flap interlocks with an adjacent flap.

G. A system as set forth in clause B or any other clause, where one flap includes a tab portion and another flap includes a slot sized to receive the tab portion.

H. A system as set forth in clause G or any other clause, where the slot portion is substantially longer than the tab portion to allow the flap to move between the substantially planar closed position and the operating position without removing the tab portion from the slot portion.

I. A system as set forth in clause B or any other clause, where the side walls of the container are perpendicular to the bottom wall, and when the flaps are in the closed position the flaps are perpendicular to the side walls.

J. A system as set forth in clause A or any other clause, where the outlet opening is defined by distal edges of the movable flap, spacing the outlet opening from the opening at the open side of the container.

K. A system as set forth in clause A or any other clause, where in the operating position the flaps define inclined converging walls.

L. A system as set forth in clause A or any other clause, where the two or more flaps include two pair of flaps, with each flap extending from a respective wall that is perpendicular to an adjacent wall, and each pair of flaps extend from parallel walls.

M. A system as set forth in clause A or any other clause, where, in the closed position, the flaps extend substantially parallel to one another.

N. A system as set forth in clause A or any other clause, where at least one flap has a tapered shape from which a tab extends for receipt in a slot in another flap.

O. A system as set forth in clause A or any other clause, where at least one flap has a non-linear slot to receive and hold a tab portion of another flap when the flaps are in the operating position.

P. A system as set forth in clause A or any other clause, where each flap has a substantially planar shape.

Q. A system as set forth in clause A or any other clause, where during movement to the operating position, the movable flap increases at least one dimension of the outlet opening.

R. A system as set forth in clause A or any other clause, where the container has a plurality of flaps interconnectable with one another to form a structure that tapers from the open side of the container toward the outlet opening.

S. A system as set forth in clause A or any other clause, comprising a supply of sheet stock material within the container, the sheet stock material having a width dimension, the container having a width dimension that is substantially the same as the width dimension of the stock material, the container further having an open side closed by two or more flaps in a substantially planar closed position, the flaps being connected together, the flaps being movable to an operating position where the flaps are displaced from the closed position to form an outlet opening spaced from the open side of the container for dispensing crumpled stock material therethrough, the opening having a width dimension that is less than the width dimension of the container.

T. A system as set forth in clause A or any other clause, where the supply of sheet stock material includes at least one of a fan-folded stack or a roll of sheet stock material.

U. A system as set forth in clause A or any other clause, where the supply includes a roll of sheet stock material having a longitudinal axis aligned with the dispensing outlet.

V. A system as set forth in clause A or any other clause, comprising a slot spaced from the open side, the slot extending substantially parallel to the width dimension of the container for withdrawing uncrumpled stock material.

W. A supply of sheet stock material for conversion into a relatively less dense dunnage product, comprising a container, and a stack of sheet stock material fan-folded on itself along generally parallel fold lines, where the stack is folded on itself about an axis perpendicular to the fold lines in the stock material, and the stack is maintained in its folded configuration by the container.

X. A supply as set forth in clause W or any other clause depending from clause W, where the stack has an unfolded width dimension before it is folded, the stock material has fold lines generally parallel to the width dimension, the container has a width dimension, and the width of the container is less than the unfolded width of the stack.

Y. A supply as set forth in clause W or any other clause depending from clause W, where the stack is folded into an inverted U-shape within the container.

Z. A supply as set forth in clause W or any other clause depending from clause W, where the container includes a central rib extending into the container over which the stack is folded.

AA. A dunnage system, comprising a container having a top that defines a flat side, and the top is movable from a closed position orthogonal to sides of the container to an outwardly-displaced operating position where the top defines an outlet opening that increases in at least one dimension as the top moves to the operating position.

AB. A packing method, comprising the steps of:

(a) drawing sheet stock material through an opening in a container, the opening being smaller than the container, whereby the sheet stock material is crumpled as it is drawn through the opening;

(b) inverting the container; and

(c) drawing sheet stock material through a slot in the container having a width substantially equal to or greater than the width of the sheet stock material, whereby the sheet stock material remains uncrumpled as it is drawn through the slot.

1. A dunnage system, comprising a container for receiving a stock material, the container having at least one movable flap that is movable between a closed position where the flap at least partially closes an open side of the container, and an operating position outwardly displaced from the closed position, where when the movable flap is in the operating position the movable flap defines a side of an outlet opening having at least one dimension that is smaller than a corresponding dimension of the open side of the container.

2. A system as set forth in claim 1, where the container is sized to contain a supply of sheet stock material, the container having a bottom wall, one or more side walls extending from respective edges of the bottom wall to define an enclosed space with an open side opposite the bottom wall, and multiple flaps that extend from respective edges of the side walls opposite the bottom wall;
where the flaps define a converging chute having a relatively larger inlet at the top of the side walls that is spaced from the outlet opening, which is relatively smaller than the inlet; and
where, in the operating position, the flaps inwardly gather and crumple sheet stock material pulled from the container through the outlet opening.

3. A system as set forth in claim 1, where in the operating position a distal end of the flap or flaps defines the outlet opening, which has at least one dimension that is smaller than a corresponding dimension of the open side of the container, whereby in the operating position the flaps inwardly gather and crumple sheet stock material pulled from the container through the outlet opening.

4. A system as set forth in claim 2, comprising means for securing the flaps in the operating position.

5. A system as set forth in claim 1, comprising means for preventing the flaps from moving beyond the operating position.

6. A system as set forth in claim 2, where in the operating position each flap interlocks with an adjacent flap.

7. A system as set forth in claim 2, where one flap includes a tab portion and another flap includes a slot sized to receive the tab portion.

8. A system as set forth in claim 7, where the slot portion is substantially longer than the tab portion to allow the flap to move between the substantially planar closed position and the operating position without removing the tab portion from the slot portion.

9. A system as set forth in claim 2, where the side walls of the container are perpendicular to the bottom wall, and when the flaps are in the closed position the flaps are perpendicular to the side walls.

10. A system as set forth in claim 1, where the outlet opening is defined by distal edges of the movable flap, spacing the outlet opening from the opening at the open side of the container.

11. A system as set forth in claim 1, where in the operating position the flaps define inclined converging walls.

12. A system as set forth in claim 1, where the two or more flaps include two pair of flaps, with each flap extending from a respective wall that is perpendicular to an adjacent wall, and each pair of flaps extend from parallel walls.

13. A system as set forth in claim 1, where, in the closed position, the flaps extend substantially parallel to one another.

14. A system as set forth in claim 1, where at least one flap has a tapered shape from which a tab extends for receipt in a slot in another flap.

15. A system as set forth in claim 1, where at least one flap has a non-linear slot to receive and hold a tab portion of another flap when the flaps are in the operating position.

16. A system as set forth in claim 1, where each flap has a substantially planar shape.

17. A system as set forth in claim 1, where during movement to the operating position, the movable flap increases at least one dimension of the outlet opening.

18. A system as set forth in claim 1, where the container has a plurality of flaps interconnectable with one another to form a structure that tapers from the open side of the container toward the outlet opening.

19. A system as set forth in claim 1, comprising a supply of sheet stock material within the container, the sheet stock material having a width dimension, the container having a width dimension that is substantially the same as the width dimension of the stock material, the container further having an open side closed by two or more flaps in a substantially planar closed position, the flaps being connected together, the flaps being movable to an operating position where the flaps are displaced from the closed position to form an outlet opening spaced from the open side of the container for dispensing crumpled stock material therethrough, the opening having a width dimension that is less than the width dimension of the container.

20. A system as set forth in claim 1, where the supply of sheet stock material includes at least one of a fan-folded stack or a roll of sheet stock material.

21. A system as set forth in claim 1, where the supply includes a roll of sheet stock material having a longitudinal axis aligned with the dispensing outlet.

22. A system as set forth in claim 1, comprising a slot spaced from the open side, the slot extending substantially parallel to the width dimension of the container for withdrawing uncrumpled stock material.

23. A supply of sheet stock material for conversion into a relatively less dense dunnage product, comprising a container, and a stack of sheet stock material fan-folded on itself along generally parallel fold lines, where the stack is folded on itself about an axis perpendicular to the fold lines in the stock material, and the stack is maintained in its folded configuration by the container.

24. A supply as set forth in claim 23, where the stack has an unfolded width dimension before it is folded, the stock material has fold lines generally parallel to the width dimension, the container has a width dimension, and the width of the container is less than the unfolded width of the stack.

25. A supply as set forth in claim 23, where the stack is folded into an inverted U-shape within the container.

26. A supply as set forth in claim 23, where the container includes a central rib extending into the container over which the stack is folded.

27. A dunnage system, comprising a container having a top that defines a flat side, and the top is movable from a closed position orthogonal to sides of the container to an outwardly-displaced operating position where the top defines an outlet opening that increases in at least one dimension as the top moves to the operating position.

28. A packing method, comprising the steps of:
(a) drawing sheet stock material through an opening in a container, the opening being smaller than the container, whereby the sheet stock material is crumpled as it is drawn through the opening;
(b) inverting the container; and
(c) drawing sheet stock material through a slot in the container having a width substantially equal to or greater than the width of the sheet stock material, whereby the sheet stock material remains uncrumpled as it is drawn through the slot.
